(19) United States
(12) Patent Application Publication
(10) Pub. No.: US 2006/0009236 A1
(43) Pub. Date: Jan. 12, 2006

(54) Determining a location

(76) Inventors: Vanu Bose, Boston, MA (US); Ragha Vendra Madyastha, Watertown, MA (US)

Correspondence Address: FISH & RICHARDSON PC, P.O. BOX 1022, MINNEAPOLIS, MN, 55440-1022, US

(21) Appl. No.: 11/148,958

(22) Filed: Jun. 9, 2005

Related U.S. Application Data
(60) Provisional application No. 60/578,265, filed on Jun. 9, 2004.

(51) Int. Cl. H04Q 7/20

(52) U.S. Cl. 455/456.1

(57) ABSTRACT

Methods and systems for determining a location using a software based radio are disclosed.

### PRIORITY TO OTHER APPLICATIONS

This application claims priority from and incorporates herein U.S. Provisional Application No. 60/578,265, filed Jun. 9, 2004, and titled “DETERMINING A LOCATION”.

### TECHNICAL FIELD

The following description relates to radio systems.

### BACKGROUND

The ability to determine the location of a cellular phone making an emergency call has been mandated by the FCC (http://www.fcc.gov/911/enhanced/). The FCC standard requires location accuracy of 100 meters for 67% of calls and 300 meters for 95% of calls. However, there is currently no feasible solution that can provide adequate position location information for GSM handsets in rural areas where the density of cell sites is low.

There are currently several types of approaches for providing emergency call (E911) location service. Both handset-based and infrastructure-based products are available for the various standards described above. Such systems have significant limitations and do not adequately solve the E911 problem for rural markets. One solution uses global positioning system (GPS) enabled handsets and another is an infrastructure based approach that utilizes either triangulation of received signals at multiple base stations or antenna array technology. These solutions have significant limitations in many applications. In particular, neither is viable in rural areas for GSM systems. GSM handsets do not widely support GPS position location and infrastructure-based solutions, which typically require measurements at three cellular towers, are problematic in rural areas with low tower density.

### SUMMARY

In some aspects, the invention includes a method for determining a location of a mobile unit using a software radio includes receiving, at a base station, a signal from the mobile unit. The method also includes determining a first estimation of a location of the mobile unit using a timing advance and determining a second estimation of the location of the mobile unit using an angle of arrival. The method also includes calculating a revised estimation of the location of the mobile unit based on the first estimation and the second estimation.

Embodiments of the invention can include one or more of the following. Calculating the revised estimation can include calculating the revised estimation using software at the base station. The mobile unit can be a cellular phone. The received signal can be an emergency 911 signal transmitted by the cellular phone.

The method can also include determining a third estimation of the location of the mobile unit using a received power. Calculating the revised estimation can include calculating the revised estimation of the location of the mobile unit based on the first estimation, the second estimation, and the third estimation. The method can also include determining a fourth estimation of the location of the mobile unit using a channel estimate developed by an equalizer. Calculating the revised estimation can include calculating the revised estimation of the location of the mobile unit based on the first estimation, the second estimation, and the fourth estimation. The method can also include determining a third estimation of the location of the mobile unit using a received power and determining a fourth estimation of the location of the mobile unit using a channel estimate developed by an equalizer. Calculating the revised estimation can include calculating the revised estimation of the location of the mobile unit based on the first estimation, the second estimation, the third estimation, and the fourth estimation. Determining the second estimation of the location of the mobile unit using the angle of arrival can include calculating the angle of arrival using two antennas. The method can also include performing signal processing on the received signal. The method can also include using a signal set of hardware for determining the location and performing the signal processing.

Determining the first estimation of the location of the mobile unit using timing advance can include determining an annulus of a predetermined width around the base station based on the timing of the received signal. Determining the second estimation of the location of the mobile unit using the angle of arrival can include receiving the signal at a first antenna and recording a first set of information about the received signal, receiving the signal at a first antenna and recording a second set of information about the received signal, and calculating an angle of arrival based on the first and second set of information about the received signal. Determining the third estimation of the location of the mobile unit using the received power can include providing a plurality of power fingerprints and comparing the received power to the power fingerprints to determine a location. The plurality of power fingerprints can include at least one of a rural fingerprint; an urban area fingerprint, an extreme urban area fingerprint; and a hilly area fingerprint.

In additional aspects, the invention includes determining a location of a mobile unit using a software radio. The method includes receiving, at a base station, a signal from the mobile unit and calculating an estimation of a location of the mobile unit based on at least two of a received power level, a timing advance, a channel estimate developed by an equalizer in the system, and an angle of arrival.

Embodiments of the invention can include one or more of the following.

Calculating the estimation of the location of the mobile unit can include calculating the estimation of the location of the mobile unit based on at least three of the received power level, the timing advance, the channel estimate developed by the equalizer in the system, and the angle of arrival. Calculating the estimation of the location of the mobile unit can include calculating the estimation of the location of the mobile unit based a combination of the received power level, the timing advance, the channel estimate developed by the equalizer in the system, and the angle of arrival.

In additional aspects, the invention includes a system that includes a software based radio contained in a base station. The base station is configured to calculate a location of the mobile unit.

Embodiments of the invention can include one or more of the following.

The software based radio can be configured to provide information about a signal strength, timing advance, and channel estimate with respect to a mobile radio. The base station can be further configured to calculate the location of the mobile unit based on a combination of on the signal strength, timing advance, and channel estimate. The software based radio can be configured to provide information about at least two of a signal strength, a timing advance, an angle of arrival and a channel estimate with respect to a mobile radio. The base station can be further configured to calculate the location of the mobile unit based on the provided information.

In additional aspects, the invention includes a system configured to receive, at a base station, a signal from the mobile unit, determine a first estimation of a location of the mobile unit using a timing advance, determine a second estimation of the location of the mobile unit using an angle of arrival, and calculate a revised estimation of the location of the mobile unit based on the first estimation and the second estimation.

Embodiments of the invention can include one or more of the following. The system can be configured to calculate the revised estimation using software running on the base station.

Advantages that can be seen in particular implementations include one or more of the following.

In some embodiments, the use of a software radio based infrastructure can provide flexibility in determining and providing position location information for wireless communication systems including GSM systems.

In some embodiments, the increased visibility of information provides additional functionality in software radio systems. For example, multiple parameters such as signal strength, timing advance and channel estimate can be combined to provide a location determination.

In some embodiments, by using multiple techniques concurrently the location of a mobile unit can be determined without requiring additional hardware to be installed at a base station.

In some embodiments, the use of a software radio based infrastructure can provide location information with no incremental hardware capital or operating expenditures by running location determination applications on the software radio system.

### BRIEF DESCRIPTION THE DRAWINGS

FIG. 1 is a block diagram of multiple parameters measured using a software based radio system.

FIG. 2 is a block diagram of a GPS position determination system.

FIG. 3 is a block diagram of a triangulation based position determination system.

FIG. 4 is a block diagram of an angle of arrival based position determination system.

FIG. 5 is a flow chart.

FIGS. 6A-6D are plots of channel estimates.

FIG. 7 is a flow chart.

FIG. 8 is a flow chart.

### DETAILED DESCRIPTION

A software radio based infrastructure can provide flexibility in determining and providing position location information for wireless communication systems including GSM systems. Without wishing to be bound by theory, it is believed that a software based radio system can also provide cost advantages over existing approaches.

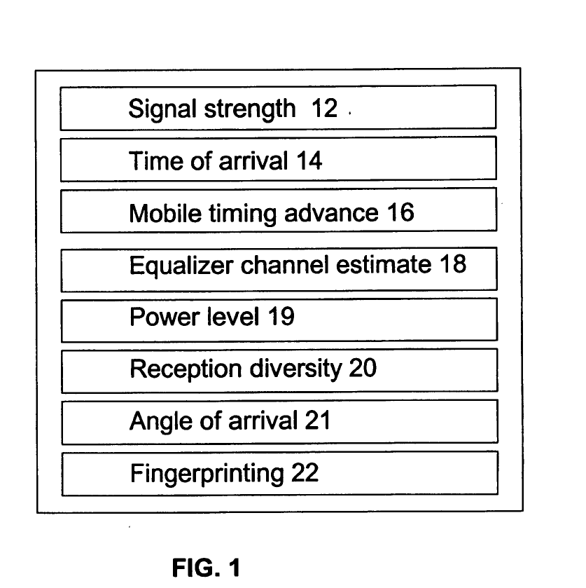

By synthesizing information from several levels of the system, including the physical layer, a software radio can generate a position estimate using several approaches concurrently without adding new equipment or antennas to the cell site. A software radio makes it possible to expose information from different parts of the system through simple APIs. Examples of APIs which can be used to determine a location include APIs for signal strength 12, time of arrival 14, mobile timing advance 16, the equalizer channel estimate 18, and reception diversity 20 (FIG. 1). In some embodiments, it may also be beneficial to use other methods of radio frequency fingerprinting 22.

In general, the increased visibility of information in a software based radio system can be used to implement new functionality in the system. In particular, the various parameters such as signal strength, timing advance and channel estimate with diversity are not easily exposed and combined in a traditional hardware based infrastructure system. In a hardware based system, the received signal strength is often measured in the radio frequency (RF) section of the system, the channel estimate is included inside the equalizer and the timing advance is set by the control software. In contrast, in a software radio system, all of these functions are implemented in software. By implementing the appropriate APIs in an existing software radio base station, this information can be collected and jointly processed.

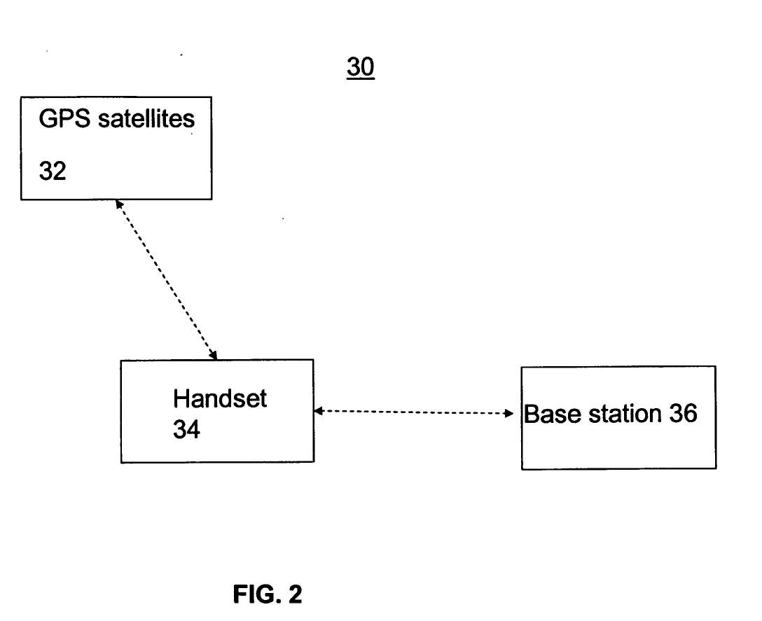

Referring to FIG. 2, one approach for location determination includes using a GPS signal and related GPS infrastructure. This approach utilizes handsets 34 that receive GPS signals and then report location information back to the base station 36. While this can be a fairly inexpensive solution, it can have two limitations. When operated indoors, the handset 34 cannot receive the signal from the GPS satellites 32. In addition, the handsets 34 do not provide altitude information. The handsets 34 can use some inertial guidance to estimate position when the satellites 32 are not available. However, if for example, an emergency call is being made from a tall building, the floor from which the call is being made cannot be readily determined. The second problem is that not all handsets 34 incorporate GPS capability. For example, few GSM handsets support this capability.

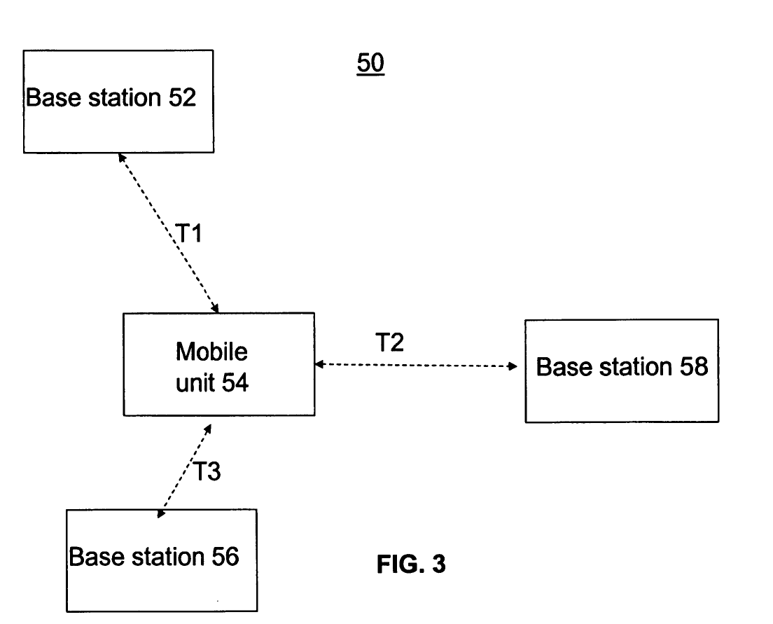

Referring to FIG. 3, another infrastructure based approach to providing position location is TDOA (Time Difference of Arrival) 50 is shown. This approach compares the time (e.g., time T1, T2, and T3) that the mobile originated signal arrives at three different base stations (e.g., base stations 52, 56, and 58). This information can be used to triangulate the position of the mobile unit 54. This approach does not work in rural areas, where the cell site density is low. In many rural areas, a handset is only within range of a single base station at any given time, ruling out triangulation as a viable method for determining location.

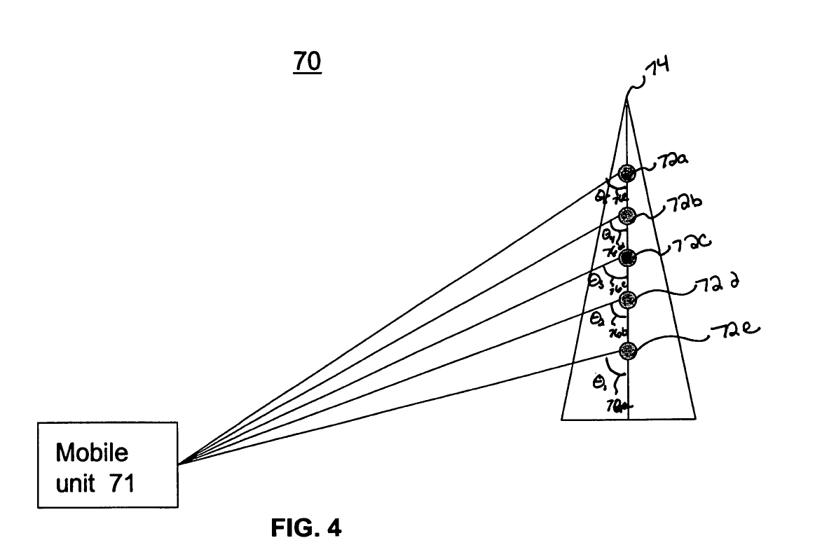

Referring to FIG. 4, another infrastructure based approach 70 uses antenna array technology. In this approach an array of regularly spaced antenna elements (e.g., elements 72a-72d) is installed on the tower 74. The signals from each element can be processed together to determine the angle of arrival of the signal (AOA) from the mobile unit 71 (e.g., angles 76a-76d). Coupled with power measurements the angle of arrival measurements can provide an accurate estimate of the mobile position. The angle of arrival approach, in isolation, can be prohibitively expensive, and requires the purchase and installation of a significant amount of equipment for each tower to obtain accurate estimates of AOAs. Companies such as Arraycom (http://www.arraycomm.com/) are commercializing antenna array technology to improve capacity of wireless systems, which may lead to lowering the costs of antenna array systems for E911 applications in the future.

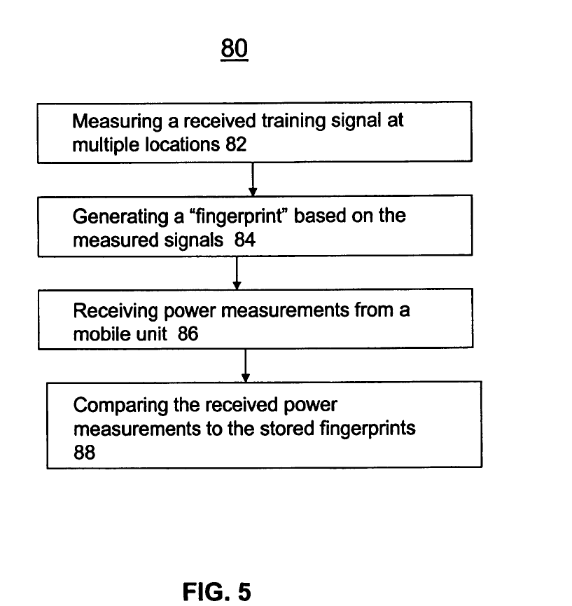

Referring to FIG. 5, a power based location determination process 80 is shown. The received RF power level from a mobile is a rough indicator of distance. The power transmitted at the mobile unit falls off roughly as one divided by the distance squared. The problem is that in multi-path environments, the power level can be corrupted by signals received from multiple paths and by ground echoes. “RF fingerprinting” involves a training phase in which the actual received power is measured 82 at multiple locations and at several base stations; these measurements constitute a “fingerprint” 84. When a mobile makes an E911 call the received power measurements 86 are compared 88 to the fingerprint database and a location estimate is determined. The RF fingerprinting approach relies on signals from multiple base stations and may not provide enough accuracy in rural applications with a low density of towers.

A software radio system can be used to create a position location system (e.g., an E911 position location system) that can work in rural areas with a low density of tower sites. Multiple techniques such as the techniques described above, can be used concurrently to define region within which the phone is located. For example, by using multiple techniques concurrently the region can be narrowed enough to meet the FCC requirements of 100 meters for 67 percent of calls and 300 meters for 95 percent of calls.

The software based radios can include interfaces for measuring one or more of signal strength, timing advance, channel estimate and angle of arrival. In some embodiments, the angle of arrival estimate can be determined based on measurements from two antennas. For example, many rural towers have 2 receive antennas for diversity reception, and these two antennas can yield a reasonable AOA estimate.

A software based radio can also be used to determine a location in regions where more than one tower is visible to the mobile unit. For example, in situations where the mobile unit is visible to more than one tower additional information can enhance mobile position determination (e.g., improve the accuracy or resolution of the position determination).

Referring back to FIG. 1, the use of a software based radio system enables a technique for determining the position location of a mobile that combines information from three or, when available, several different parameters that can be monitored by the base station. Such parameters can include received power level 19, timing advance 14, the channel estimate developed by the equalizer in the system 18, and angle of arrival (AOA) if available 21. While the described approach is focused on rural GSM applications, the approach can also be used in more densely populated areas.

In a traditional hardware base station, these parameters are often buried inside chips or hardware subsystems and cannot be queried and synthesized by a single entity within the system. A software radio makes it possible to expose these elements from different parts of the system through simple APIs (e.g., APIs for determining a location based on the parameters shown in FIG. 1). The location determination algorithm is one example of how this increased visibility of information can be used to implement new functionality. Other embodiments are possible.

Similar to the RF fingerprinting approach described above in relation to FIG. 5, received RF power level can be compared to a database of training results. While this information from a single base station is not enough to pinpoint a location, the measurement helps to narrow down the possible set of locations.

In GSM, the base station advances the timing of the transmitted signal in order to compensate for the distance the signal travels to the mobile. The timing advance is continually adjusted as the location of the mobile unit changes. The advance is adjusted in steps of 3 μsec, which roughly corresponds to a distance range of 3000 feet (900 meters). The timing advance can therefore narrow the location of the mobile to an annulus of width 3000 feet around the base station. Other time steps and distances can also be used. For example, a time step of 1 usec and a width of 1000 feet could be used.

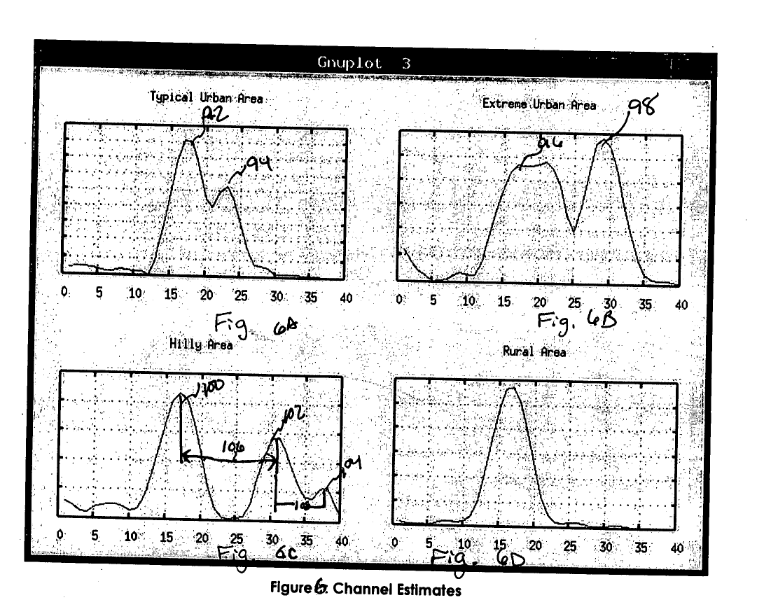

Referring to FIGS. 6A-6D, channel estimates for a signal transmitted between the base station and mobile unit are shown. As part of the signal processing of the GSM signal, the base station performs an estimate of the channel between the mobile and the base station. This estimate is recomputed every time slot. The channel estimate changes based on terrain. As shown in FIGS. 6A and 6B, in an area with a lot of tall buildings, the channel would show multiple paths close together. The multiple paths are indicated by the peaks in the signal. For example, the signal in FIG. 6A includes two closely spaced peaks 92 and 94 and the signal in FIG. 6B includes two closely spaced peaks 96 and 98. In contrast, in an area with large hills the channel may contain two, three, or more paths separated by a longer time. For example, the signal shown in FIG. 6C includes three peaks 100, 102, and 104 separated by time intervals 106 and 108. In yet another example, in an open plain a single path may approximate the ideal additive white Gaussian noise channel (FIG. 6D).

In many rural base stations a second antenna is installed for diversity reception. This greatly increases the received signal to noise ration (SNR) in multi-path fading environments, leading to superior performance. An added benefit is the potential to calculate an angle of arrival (AOA) estimate. While two antennas do not provide an accurate enough AOA estimate in isolation, in conjunction with the other resources listed above the AOA measurement can provide a valuable parameter to help refine the position estimate of the E911 caller. The value of the software radio is that the AOA need not be calculated for every mobile, but only for the E911 callers.

In general, a software based radio system can monitor received power level, timing advance, channel estimate, and AOA (when necessary). This is a pure software modification that can be downloaded to an existing base station.

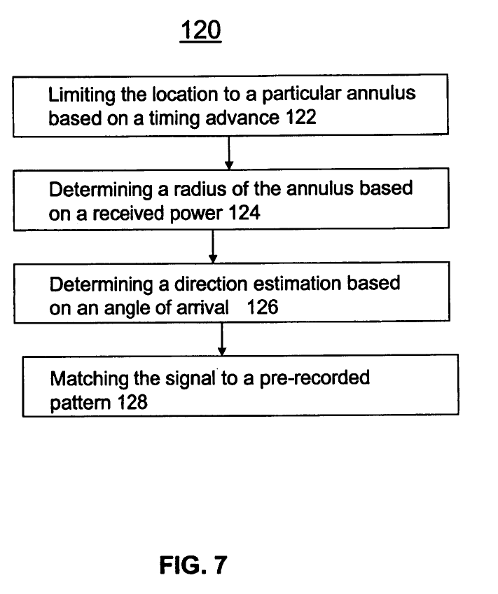

As shown in FIG. 7, a process for determining a location based on multiple measurements is shown. The timing advance constrains the mobile to lie in an annulus; the width of the annulus is 3000 feet (900 meters) as determined by the timing advance step 122. A radius of the annulus is determined 124 by the received power to get an approximation of distance. The AOA determines 126 a rough direction from which the call is placed. Finally, the particular location within the annulus is determined by matching 128 the signal to pre-recorded patterns of both received power and channel estimation.

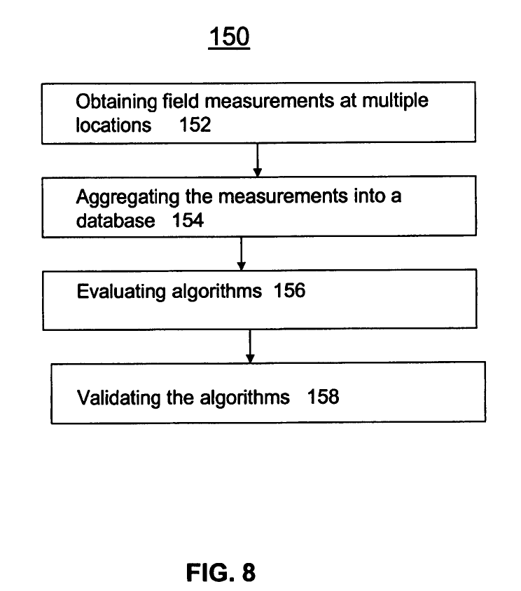

Referring to FIG. 8, a setup process 150 for configuring and testing a software based radio system is shown. During the setup process, live field measurements of GSM mobile phones at various locations can be obtained 152. The field measurements can include taking a GPS reading at the mobile location and capturing the signal strength, timing advance and channel estimate at the base station. These values will be saved in a file tagged with the GPS location.

After collecting the measurements, the measurements will be assembled into a database 154 and algorithms will be evaluated 156 for translating between the parameter values and an actual position. For example, a candidate algorithm will mostly likely take a sequential approach, narrowing down the search space by timing advance and the received power, which define an annulus in which the mobile lies. The channel and AOA estimates will then be used to distinguish between different locations on the annulus. Once a reasonable algorithm or algorithms has/have been determined, additional field measurements will be taken to validate 158 the model. Some of these new measurements will be taken at new locations to test the robustness of the model to new inputs.

Finally, for applications in a non-rural environment, additional measurements at multiple sites can be examined to evaluate the enhancement to position determination in the cases where more than one tower can hear the mobile signal.

There has been described novel apparatus and techniques for locating a position. It is evident that those skilled in the art may now make numerous modifications and uses of and departures from specific apparatus and techniques herein disclosed without departing from the inventive concepts. Consequently, the invention is to be construed as embracing each and every novel feature and novel combination of features present in or possessed by the apparatus and techniques herein disclosed and limited solely by the spirit and scope of the appended claims.

Other implementations are within the scope of the following claims.

What is claimed is:

1. A method for determining a location of a mobile unit using a software radio, the method comprising:
receiving, at a base station, a signal from the mobile unit;
determining a first estimation of a location of the mobile unit using a timing advance;
determining a second estimation of the location of the mobile unit using an angle of arrival; and
calculating a revised estimation of the location of the mobile unit based on the first estimation and the second estimation.

2. The method of claim 1, wherein calculating a revised estimation comprises calculating the revised estimation using software at the base station.

3. The method of claim 1, wherein the mobile unit is a cellular phone.

4. The method of claim 3, wherein the received signal is an emergency 911 signal transmitted by the cellular phone.

5. The method of claim 1, further comprising:
determining a third estimation of the location of the mobile unit using a received power.

6. The method of claim 5, wherein calculating the revised estimation comprises calculating the revised estimation of the location of the mobile unit based on the first estimation, the second estimation, and the third estimation.

7. The method of claim 1, further comprising:
determining a fourth estimation of the location of the mobile unit using a channel estimate developed by an equalizer.

8. The method of claim 7, wherein calculating the revised estimation comprises calculating the revised estimation of the location of the mobile unit based on the first estimation, the second estimation, and the fourth estimation.

9. The method of claim 1, further comprising:
determining a third estimation of the location of the mobile unit using a received power; and
determining a fourth estimation of the location of the mobile unit using a channel estimate developed by an equalizer;
wherein calculating the revised estimation comprises calculating the revised estimation of the location of the mobile unit based on the first estimation, the second estimation, the third estimation, and the fourth estimation.

10. The method of claim 1, wherein determining the second estimation of the location of the mobile unit using the angle of arrival comprises calculating the angle of arrival using two antennas.

11. The method of claim 1, further comprising performing signal processing on the received signal.

12. The method of claim 11, using a signal set of hardware for determining the location and performing the signal processing.

13. The method of claim 1, wherein determining the first estimation of the location of the mobile unit using timing advance comprises determining an annulus of a predetermined width around the base station based on the timing of the received signal.

14. The method of claim 1, wherein determining the second estimation of the location of the mobile unit using the angle of arrival comprises:
receiving the signal at a first antenna and recording a first set of information about the received signal;
receiving the signal at a first antenna and recording a second set of information about the received signal; and
calculating an angle of arrival based on the first and second set of information about the received signal.

15. The method of claim 1, wherein determining the third estimation of the location of the mobile unit using the received power comprises:
providing a plurality of power fingerprints; and
comparing the received power to the power fingerprints to determine a location.

16. The method of claim 15 wherein the plurality of power fingerprints includes at least one of a rural fingerprint; an urban area fingerprint, an extreme urban area fingerprint; and a hilly area fingerprint.

17. A method for determining a location of a mobile unit using a software radio, the method comprising:
receiving, at a base station, a signal from the mobile unit;
calculating a estimation of a location of the mobile unit based on at least two of a received power level, a timing advance, a channel estimate developed by an equalizer in the system, and an angle of arrival.

18. The method of claim 17, wherein calculating the estimation of the location of the mobile unit comprises calculating the estimation of the location of the mobile unit based on at least three of the received power level, the timing advance, the channel estimate developed by the equalizer in the system, and the angle of arrival.

19. The method of claim 17, wherein calculating the estimation of the location of the mobile unit comprises calculating the estimation of the location of the mobile unit based a combination of the received power level, the timing advance, the channel estimate developed by the equalizer in the system, and the angle of arrival.

20. A system comprising:
a software based radio contained in a base station, wherein the a base station is configured to calculate a location of the mobile unit.

21. The system of claim 20, wherein the software based radio is configured to provide information about a signal strength, timing advance, and channel estimate with respect to a mobile radio.

22. The system of claim 21, wherein the base station is further configured to calculate the location of the mobile unit based on a combination of on the signal strength, timing advance, and channel estimate.

21. The system of claim 20, wherein the software based radio is configured to provide information about at least two of a signal strength, a timing advance, an angle of arrival and a channel estimate with respect to a mobile radio.

22. The system of claim 21, wherein the base station is further configured to calculate the location of the mobile unit based on the provided information.

23. A system configured to:
receive, at a base station, a signal from the mobile unit;
determine a first estimation of a location of the mobile unit using a timing advance;
determine a second estimation of the location of the mobile unit using an angle of arrival; and
calculate a revised estimation of the location of the mobile unit based on the first estimation and the second estimation.

24. The system of claim 23, wherein the system is further configured to calculate the revised estimation using software running on the base station.
